(19) United States
(12) Patent Application Publication
(10) Pub. No.: US 2011/0112972 A1
(43) Pub. Date: May 12, 2011

(54) Method And Apparatus For Negotiating A Real Estate Listing Transaction Using A Networked Communications System

(76) Inventor: Timothy Michael Hughes, Corona, CA (US)

(21) Appl. No.: 12/943,850

(22) Filed: Nov. 10, 2010

Related U.S. Application Data
(60) Provisional application No. 61/260,775, filed on Nov. 12, 2009.

(51) Int. Cl. G06Q 50/00

(52) U.S. Cl. 705/313

(57) ABSTRACT

A method for negotiating areal estate listing transaction between a seller and a plurality of real estate listing agencies comprises steps of: providing a server; providing at least one computer operable by a seller of real property; providing at least one computer operable by one or more potential real estate listing agencies for the real property; networking with each other, using a networked communications system, each of the server, the at least one computer operable by the seller of real property, and the at least one computer operable by the one or more potential real estate listing agencies; accepting real property information input into the computer operable by the seller and transmitted to the server over the networked communications system; using the server, generating a webpage displaying at least some of the real property information; accepting competing offers to list the real property, wherein the competing offers are input into the at least one computer operable by the one or more potential real estate listing agencies and transmitted to the server over the networked communications system; using the server, processing the competing offers to provide proposed listing terms for the seller; and transmitting the proposed listing terms to the seller over the networked communications system. Apparatus associated with the method are also disclosed herein.

This application claims priority based on Provisional Application Ser. No. 61/260,775 filed Nov. 12, 2009, Said provisional application is incorporated herein by reference in its entirety.

### BACKGROUND OF THE INVENTION

The present invention pertains to a method and apparatus for negotiating a real estate listing transaction using a networked communications system.

A variety of networked communication systems are known, the Internet being the most prevalent. The Internet is a widely used global data communications system. There are a variety of known Internet websites. Further, there are several methods and apparatus known for accessing Internet websites and interacting with those websites. For example, many websites allow buyers and sellers to search and view real estate listings. Such websites may also provide a forum for buyers and sellers and/or their respective real estate agents to contact each other. Nevertheless, effective and efficient use of the Internet has been limited in regard to the negotiation of real estate listing transactions.

Finding a real estate agency with which to market real property conventionally involves a seller individually contacting (e.g., by telephone or otherwise) various pre-selected and potential real estate agencies. Negotiation of an ensuing real estate listing transaction thereafter usually requires that the seller separately negotiate listing terms with each of the potential real estate agencies. Given the amount of time required to make such individual contacts and separately negotiate real estate listing transactions, which can sometimes be an uncomfortable process, sellers typically begin the process by contacting an individual real estate broker or agent with whom the seller has a prior relationship. A 2006 National Association of Realtors (NAR) survey concluded that nearly 75% of sellers list their properties for sale with a broker found through either a referral or a prior relationship and 69% of sellers only contact one real estate broker. As such, without competition from multiple prospective real estate listing agencies, a premium is often charged on pricing o commissions for real estate listing transactions.

In most industries, competition creates pricing pressure that brings supply and demand into equilibrium, but this has not yet occurred in the real estate industry. In the real estate industry, the average commission rate nationally remains at approximately 5% despite an oversupply of real estate brokers and undersupply of transactions. Numerous surveys show that the public believes real estate commissions are too high. Even real estate broker trade groups' own surveys support the dissatisfaction among the public regarding high commissions. For example, in an article published on Aug. 1, 2007 in Realtor, the Business Tool for Real Estate Professionals, the following statistic was cited with respect to commission rates: “Sixty-three percent (63%) of those who recently bought or sold said they believe a 5 percent or 6 percent commission on a $300,000 home is too high. The CFA survey didn't cover other price points . . . . ”

All known Internet-based models for contacting prospective real estate listing agencies as well as searching and viewing property information are believed to rely on the Internet Data Exchange (IDX) or a similar data feed service, which is tied to the privately governed Multiple Listing Service (MLS) and limited in respect to the amount and type of property information searchable and viewable by the public thereby. Such Internet-based models include those available through www.zillow.com, www.trulia.com, www.realtor.com, www.ziprealty.com, and the like. Despite its shortcomings, IDX has been found to be a beneficial tool for real estate transactions.

Nevertheless, financial efficiencies imparted by use of IDX are generally not evenly distributed amongst involved parties. Real estate agencies' transactions costs are considerably reduced by use of IDX, as real estate agencies are no longer as actively engaged in helping buyers and sellers find each other. Instead, buyers' transaction costs have increased because they are now investing more of their own time to locate desirable real property via the Internet, and sellers' transaction costs have increased due to real property price appreciation along with a correspondingly insignificant reduction in commission rates charged by real estate agencies in negotiated listing transactions.

According to the NAR, during the 2006 calendar year eighty-percent (80%) of buyers used the Internet during their home searches and twenty-four-percent (24%) actually found the home that they purchased on the Internet as compared to only two-percent (2%) in 1997. Conversely, the number of buyers reporting real estate brokers as the first source of such information decreased from fifty-percent (50%) in 1997 to thirty-six-percent (36%) in 2006. Hence, despite the “Internet revolution,” buyers' and sellers' transaction costs continue to increase, while brokers' transaction costs continue to decrease. Brokers no longer have to spend as much time showing property to prospective buyers, who are searching and viewing properties on the Internet, while broker revenue has increased due to real property price appreciation and commission rates that have remained relatively unchanged.

Thus, improved methods and apparatus are needed for negotiating real estate listing transactions and reducing commission rates charged by real estate listing agencies.

### SUMMARY OF THE INVENTION

An improved method for negotiating a real estate listing transaction between a seller and a plurality of real estate listing agencies comprises steps of: providing a server; providing at least one computer operable by a seller of real property; providing at least one computer operable by one or more potential real estate listing agencies for the real property; networking with each other, using a networked communications system, each of the server, the at least one computer operable by the seller of real property, and the at least one computer operable by the one or more potential real estate listing agencies; accepting real property information input into the computer operable by the seller and transmitted to the server over the networked communications system; using the server, generating a webpage displaying at least some of the real property information; accepting competing offers to list the real property, wherein the competing offers are input into the at least one computer operable by the one or more potential real estate listing agencies and transmitted to the server over the networked communications system; using the server, processing the competing offers to provide proposed listing terms for the seller; and transmitting the proposed listing terms to the seller over the networked communications system. Apparatus associated with the method are also disclosed herein.

### BRIEF DESCRIPTION OF THE DRAWINGS

FIG. 1 is a schematic diagram of one embodiment of a networked communications system in accordance with methods and apparatus of the invention.

FIG. 2 is a flow diagram associated with one embodiment of a method and apparatus of the invention.

FIG. 3 illustrates one embodiment of a computer used in accordance with methods and apparatus of the invention.

FIG. 4 is a representation of one embodiment of an introductory webpage generated by a server in accordance with methods and apparatus of the invention.

FIG. 5 is a representation of one embodiment of a webpage generated by a server to facilitate input of property information by a seller in accordance with methods and apparatus of the invention.

FIG. 6 is a representation of one embodiment of a webpage generated by a server and transmitted to a potential listing agent seeking proposed listing terms in accordance with methods and apparatus of the invention.

FIG. 7 is a representation of one embodiment of a webpage of potential listing agent's proposed listing terms and a ranking thereof, which webpage is generated by a server in accordance with methods and apparatus of the invention.

FIG. 8 is a representation of one embodiment of a webpage providing information from one potential listing agent with that agent's proposed listing terms, which webpage is generated by a server in accordance with methods and apparatus of the invention.

FIG. 9 is a representation of one embodiment of a webpage providing information from another potential listing agent with that agent's proposed listing terms, which webpage is generated by a server in accordance with methods and apparatus of the invention.

FIG. 10 is a representation of one embodiment of a webpage providing information from yet another potential listing agent with that agent's proposed listing terms, which webpage is generated by a server in accordance with methods and apparatus of the invention.

FIG. 11 is a representation of one embodiment of a webpage providing notification of seller's contact information to the potential listing agent associated with the proposed listing terms selected by the seller, which webpage is generated by a server in accordance with methods and apparatus of the invention.

FIG. 12 is a representation of one embodiment of a communication from the potential listing agent selected by the seller, which communication is generated by a server and transmitted to the seller in accordance with methods and apparatus of the invention.

### DETAILED DESCRIPTION OF PREFERRED EMBODIMENTS

The following describes a method and apparatus for negotiating a real estate listing transaction using a networked communications system. Preferably, the networked communications system is a data communications system. An exemplary networked data communications system comprises the Internet. As used herein, the “Internet” refers to a global data communications system comprising hardware and software infrastructure and providing connectivity between computers. Although frequent reference is made to the Internet throughout, it is to be understood that any suitable hardware and software infrastructure can be used for negotiating real estate listing transactions in accordance with the present invention.

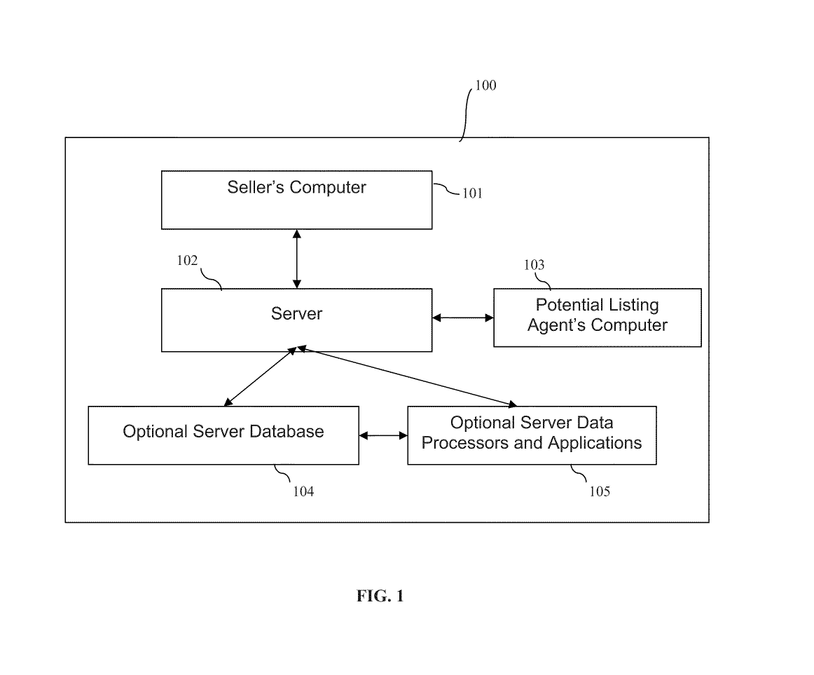

FIG. 1 is a schematic diagram of one embodiment of a networked communications system 100 in accordance with methods and apparatus of the invention. As illustrated therein, at least three computers are connected via a networked data communications system such as the Internet. The at least three computers comprise a seller's computer 101, a server 102, and a potential listing agent's computer 101 The seller's computer 101 interacts with the server 102 by accessing a website hosted on the server 102 or accessing any other networked computer that is indirectly connected to the server 102. Similarly, the potential listing agent's computer 103 interacts with the server 102 by accessing a website hosted on the server 102 or accessing any other networked computer that is indirectly connected to the server 102.

Transmitting information across the networked communications system 100 may be accomplished using any suitable methodology, including but not limited to: e-mail, File Transfer Protocol (FTP), Common Gateway Interface (CGI), Hyper Text Transmission Protocol (HTTP), or any application allowing multiple computers to communicate with each other over such a communications system. For example, the transmission of information between the seller's computer 101, the server 102, and the potential listing agent's computer 103 can be accomplished using any suitable web browsing application operating on one or more of the communicating computers. For example, Microsoft Corporation's INTERNET EXPLORER or Apple Inc.'s SAFARI web browsing applications are widely available and suitable for transmitting information according to the present invention.

The seller's computer 101 comprises any device that allows a user to operatively connect to the server 102. The seller's computer 101 allows its user to input information regarding a real property and transmit the property information to the server 102. Examples of property information include, for example, a written description of a property's features, amenities, dimensions, or other characteristics; property tax information; address; images; and videos. Property information submitted is used to create a real estate listing on the server 102,

The server 102 may be a single computer or a network of computers capable of accessing the Internet and displaying property information publicly via a website. As used herein, the term “website” is intended to include any one or more webpages displaying the property information. The server 102 may include, or be connected to, an optional server database 104, which can accept data and store the data in a searchable and randomly accessible database. Any suitable server database 104 can be used for this purpose. Examples of such a server database 104 include, but are not limited to, Microsoft Corporation's ACCESS, Structured Query Language (SQL), or similar databases. The server database 104 allows the server 102 to collect, access, and process historical data from all property information collected by the server 102.

To accept incoming data, process data collected, and display property information on a website, the server 102 may optionally include one or more data processors and/or applications 105 capable of interpreting, parsing, and processing the property information transmitted from the seller's computer 101 or any other computer on the Internet, Examples of server applications 105 include, but are not limited to, web-based applications, database applications, firewall applications, anti-virus applications, image processing applications, spreadsheet applications, and word processing applications.

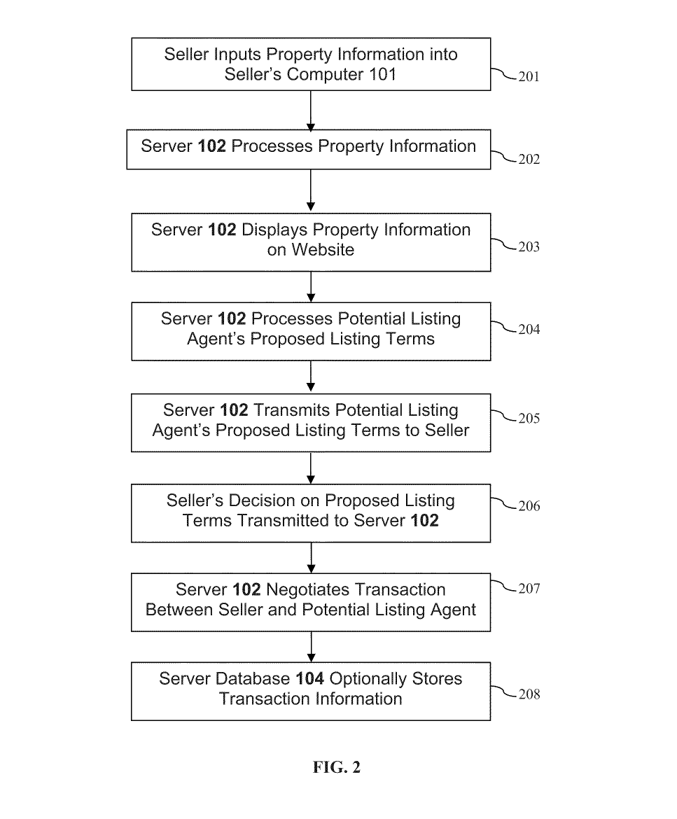

FIG. 2 illustrates a flow diagram associated with one embodiment of a method and apparatus for negotiating a real estate listing transaction using a networked communications system in accordance with the present invention. In describing FIG. 2, reference is made to components of the networked communications system of FIG. 1. Further, in describing FIG. 2, reference is made to the three computers described in relation to FIG. 1—i.e., the seller's computer 101, the server 102, and the potential listing agent's computer 103,

Any suitable computer can be used for each of the computers 101, 102, 103 in the present invention. As used herein, “computer” refers to any machine capable of manipulating data according to a set of instructions.

In an exemplary embodiment, each of the at least three computers comprises an integrated circuit. A general purpose computer has four main components: the arithmetic logic unit (AUX), the control unit, the memory, and the input and output devices (collectively termed I/O). These parts are interconnected by busses, often made of groups of wires. Inside each of these parts are thousands to trillions of small electrical circuits that can be turned off or on by means of an electronic switch. The circuits are arranged in logic gates so that one or more of the circuits may control the state of one or more of the other circuits. The control unit, ALU, registers, and basic I/O (and often other hardware closely linked with these) are collectively known as a central processing unit (CPU). The CPU comprises a single integrated circuit called a microprocessor in an exemplary embodiment.

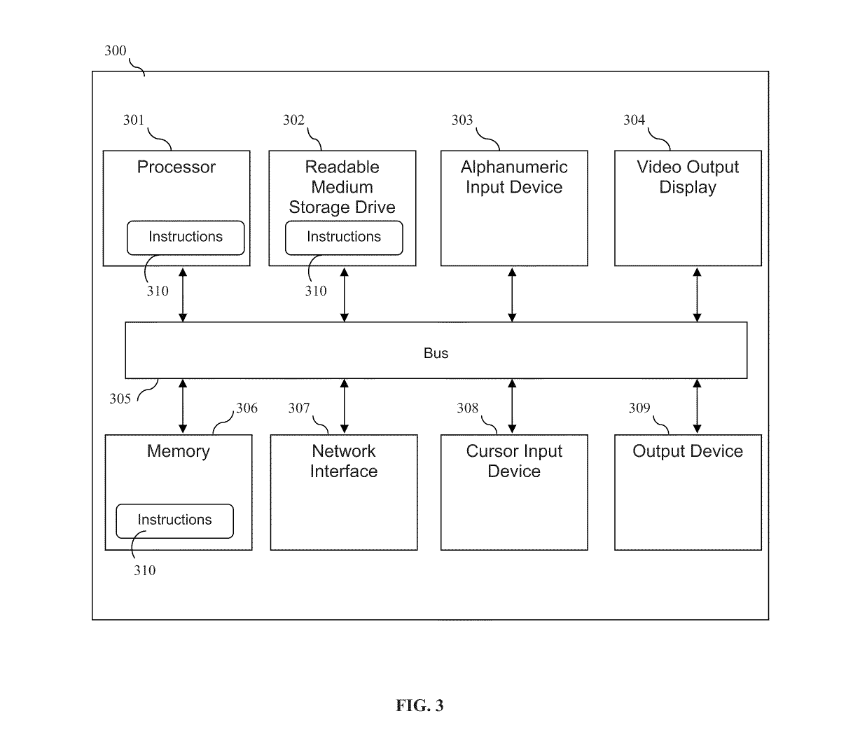

FIG. 3 illustrates one embodiment of a computer 300 used in accordance with methods and apparatus of the invention. The exemplary computer 300 of FIG. 3 comprises a microprocessor 301, a readable-medium storage drive 302, an alphanumeric input device 303, a video output display 304, a bus 305, a memory 306, a network interface 307, an input device 308, and an output device 309.

The computer 300 comprises any suitable processor 301. In one embodiment, the processor 301 comprises a central processing unit (CPU) and/or a graphics processing unit (GPU), which can accept, interpret, and process instructions 310 from any component of the computer 300.

The computer 300 comprises any suitable readable-medium storage drive 302. As used herein, the term “readable-medium” includes a single medium or multiple media capable of storing one or more sets of instructions. Such media include, for example, those capable of storing, encoding, and/or carrying a set of instructions for execution by the computer 300 in performing methods of the present invention. As such, the readable-medium storage drive 302 illustrated in FIG. 3 comprises a hard disk drive, flash memory drive, or any similar device for storing data. The readable-medium storage drive 302 is capable of storing information using any suitable media. Exemplary media include those provided by random access memory (RAM), read-only memory (ROM) (e.g., EPROM, PROM, FPROM, and OTP NVM media), flash memory (e.g., EEPROM), magnetic disk drives, magneto-optical disk drives, and optical disk drives (e.g., CD-ROM and DVD-ROM disk drives).

The computer 300 exemplified in FIG. 3 comprises any suitable alphanumeric input device 302. Examples of suitable alphanumeric input devices 303 include keyboards, keypads, and similar devices that accept control signals from a user.

The computer 300 comprises any suitable video output display 304. For example, a video output display 304 can be any viewable screen displaying output information. Exemplary video output displays 304 include comprising liquid crystal display (LCD) and cathode ray tube (CRT) technologies.

The computer 300 comprises any suitable memory 306. For example, the memory 306 comprises any device that provide for temporary or permanent storage of information for the computer 300. Examples of memory include, but are not limited to, static memory modules and dynamic memory modules.

The computer 300 comprises any suitable network interface 307. For example, a network interface 307 is any device that allows connection of the computer 300 to a communications system, Any suitable network interface 307 can be used in accordance with the present invention. Exemplary network interfaces 307 include an Ethernet card or modem. Exemplary communication systems include a local area network (LAN), an intranet, and the Internet.

The computer 300 embodied in FIG. 3 comprises any suitable input device 308. For example, a cursor input device such as, a mouse, allows a user to interact with and navigate through a user interface (UI) on the computer 300.

The computer 300 embodied in FIG. 3 comprises any suitable output device 309. Any of a variety of known output devices 309 can be used. For example, one such output device 309 comprises a printer. All of the described components of the computer 300 may be interconnected by a bus 305, which allows the various components to interact and transfer data, information, instructions, etc.

To accomplish the various methods described herein, a computer 300 may store and execute a single application or series of applications. It is to be understood that a computer application can be written in any form of programming language, including compiled or interpreted languages. Applications may be stand-alone, modules, subprograms, components, or subroutines. In exemplary embodiments, operations may be performed by one or more computers executing applications that perform functions and generate output.

Now again referring to FIG. 2, using a seller's computer 101, in a first step 201 property information is input by a seller into the networked communications system 100 using any suitable method and apparatus. For example, such property information can be input into the seller's computer 101 using a keyboard, scanner, disk drive, modem, network card, and/or mouse.

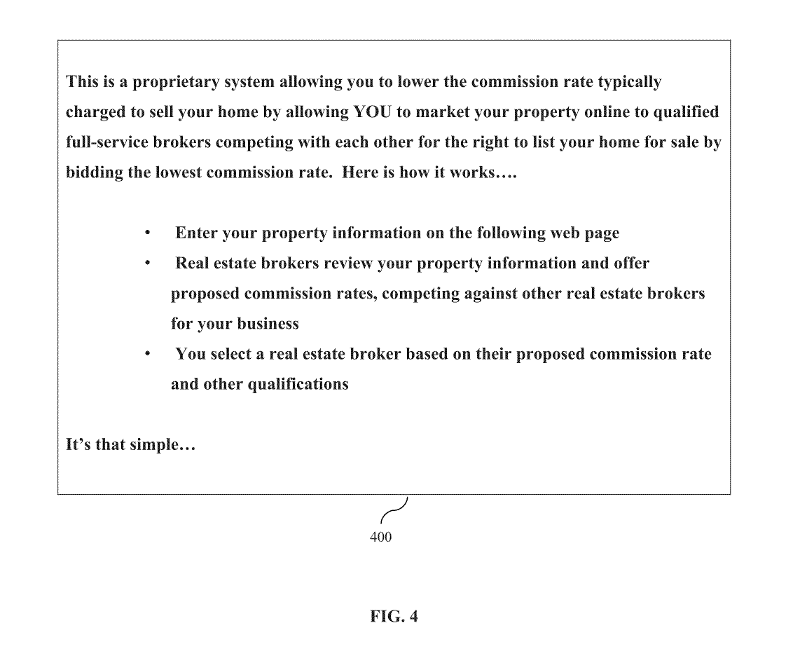

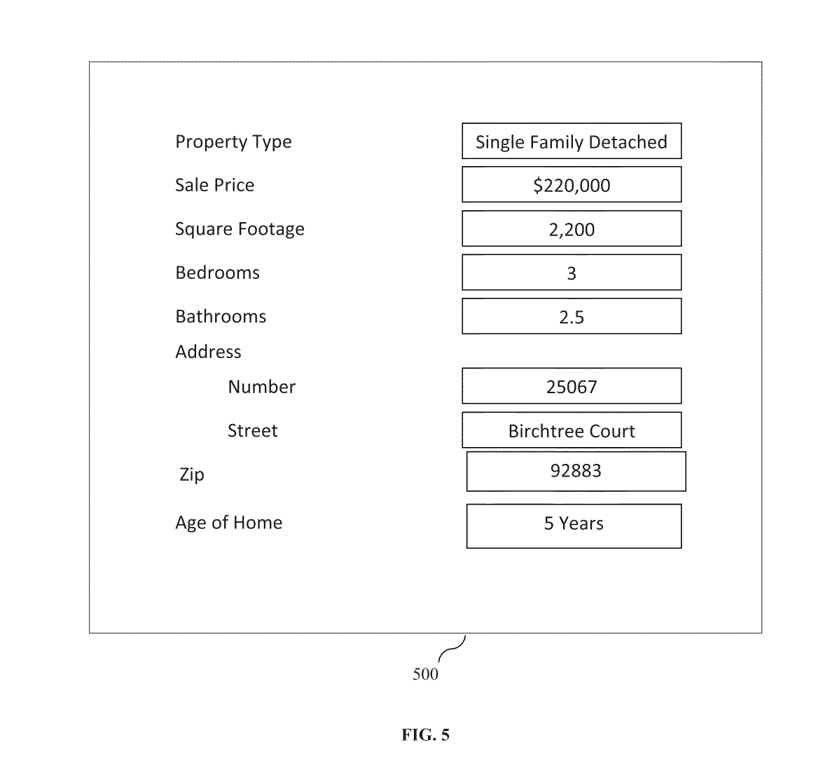

FIG. 4 is a representation of one embodiment of an introductory webpage 400 generated by the server 102 in accordance with methods and apparatus of the invention. The introductory webpage 400 provides instructions to the seller on how to use the website to efficiently negotiate areal estate listing transaction. FIG. 5 is a representation of one embodiment of a webpage 500 generated by the server 102 to facilitate input of property information by the seller in accordance with methods and apparatus of the invention.

In a further embodiment, the property information input by the seller is temporarily or permanently stored in memory of the seller's computer 101. The seller's computer 101 then transfers the property information to the server 102 via the Internet or other networked data communications system.

In a second step 202, the server 102 processes the property information. In processing the property information, the property information may be validated, organized, and/or parsed using any suitable method and apparatus. The processed property information is then optionally stored in the server database 104.

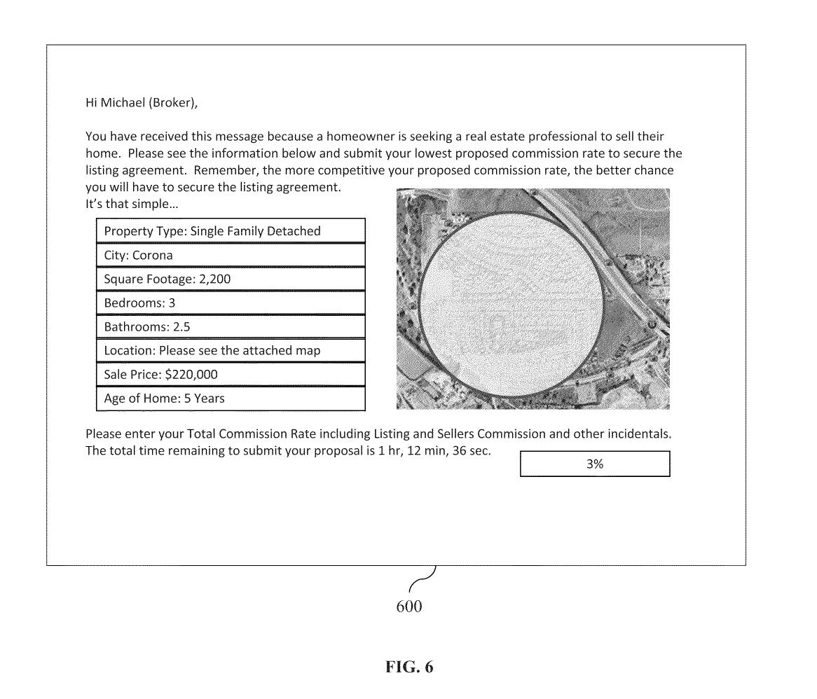

In a third step 203, after the property information is processed, the server 102 generates a website displaying the property information. In an exemplary embodiment, the website is generated using Hyper Text Markup Language (HTML), Hypertext Preprocessor language (PHP), or similar programming languages. In a further embodiment, the server 102 inserts advertising or other information along with the property information in the generated website. Finally, the server 102 causes the website to be publicly displayed on the Internet or displayed on another networked data communications system. FIG. 6 is a representation of one embodiment of a webpage 600 generated by the server 102 and transmitted to a potential listing agent seeking proposed listing terms in accordance with methods and apparatus of the invention.

In one embodiment, the generated website allows potential listing agents o search property information and submit offers of proposed listing terms (i.e., terms including the broker's commission rate) to the seller. Offers of proposed listing terms are input into the networked communications system 100 using any suitable method and apparatus. For example, such proposed listing terms can be input into the potential listing agent's computer 103 using a keyboard, scanner, disk drive, modem, network card, and/or mouse. In an exemplary embodiment, a limited time period (“Proposal Period”) is defined by the server 102 during which time period potential listing agents may. submit oilers.

In another embodiment, the generated website allows potential listing agents to search property information and submit bids to the server 102 on proposed listing terms (e.g., broker's commission rate). According to a further embodiment, the generated website allows potential listing agents to submit multiple bids to the server 102 on proposed listing terms. The multiple bids may be submitted by specifying, for example, more than one discrete commission rate or as an initial commission rate along with a lowest acceptable commission rate, with the understanding that the commission rate would be incrementally lowered by an incremental amount set by the server 102 or lowered by an incremental amount input by the potential listing agent as part of the bid on proposed listing terms. Bids on proposed listing terms are input into the networked communications system 100 using any suitable method and apparatus. For example, such proposed listing terms can be input into the potential listing agent's computer 103 using a keyboard, scanner, disk drive, modem, network card, and/or mouse. In an exemplary embodiment, a limited time period (“Bid Period”) is defined by the server 102 during which time period potential listing agents may submit such bids.

In a fourth step 204, the server 102 accepts and processes proposed listing terms from one or more potential listing agent's computers 103, which agents have viewed the publicly accessible website and have elected to submit an offer or bid on such proposed listing terms. Preferably, the potential listing agents are pre-qualified full service real estate brokers. Such brokers can be pre-qualified using any suitable method and apparatus. For example, in one embodiment, such brokers are “pre-qualified” in that they have signed an agreement with an entity operating the server 102, in which agreement the broker promises to deliver brokerage services at the commission rate encompassed within any proposed listing terms offered to a seller by that broker and selected by that seller.

In processing the proposed listing terms, the proposed listing terms may be validated, organized, and/or parsed by the server 102 using any suitable method and apparatus. In one embodiment, the proposed listing terms are organized by the server 102 in a ranking from lowest proposed commission rate to highest proposed commission rate (i.e., a “ranking”). In another embodiment, the proposed listing terms are organized by the server 102 using an auction-type methodology to identify the bid on proposed listing terms having the lowest commission rate (i.e., the “winning bid”). According to a further aspect of this embodiment, when multiple bids are submitted by one potential listing agent, the server 102 processes those bids by evaluating them against any bids received from other potential listing agents in order of decreasing commission rate. If a first potential listing agent's bid commission rate is higher than a second potential listing agent's bid commission rate, the server 102 uses the second potential listing agent's bid commission rate as the winning bid against which to evaluate further bid commission rates until there are no other potential listing agent's bid commission rates that are lower. At that time, the potential listing agent submitting the bid with the base commission rate becomes the overall winner of the auction. In a further embodiment, the proposed listing terms and/or ranking and/or best bid are temporarily or permanently stored in the server database 104.

In a fifth step 205, after processing all the potential listing agent's proposed listing terms, the server 102 then transmits the competing potential listing agent's proposed listing terms to the seller as one or more offers of listing terms. In one embodiment, the proposed listing terms transmitted to the seller are those associated with the winning bid when an auction-type methodology is used by the server 102 in processing the proposed listing terms. In another embodiment, the proposed listing terms are those transmitted to the seller including those offered by more than one potential listing agent. According to a further aspect of this embodiment, the ranking of such terms is also transmitted to the seller. The proposed listing terms and ranking may be transmitted to the seller via a website accessible by the seller's computer 101 or the proposed listing terms and/or ranking may be transmitted directly to the seller's computer 101 or another computer within the networked communications system 100 via e-mail or another suitable method. In a further embodiment, the proposed listing terms and/or ranking are temporarily or permanently stored in memory of the seller's computer 101 or other computer used by the seller in accessing the proposed listing terms and/or ranking

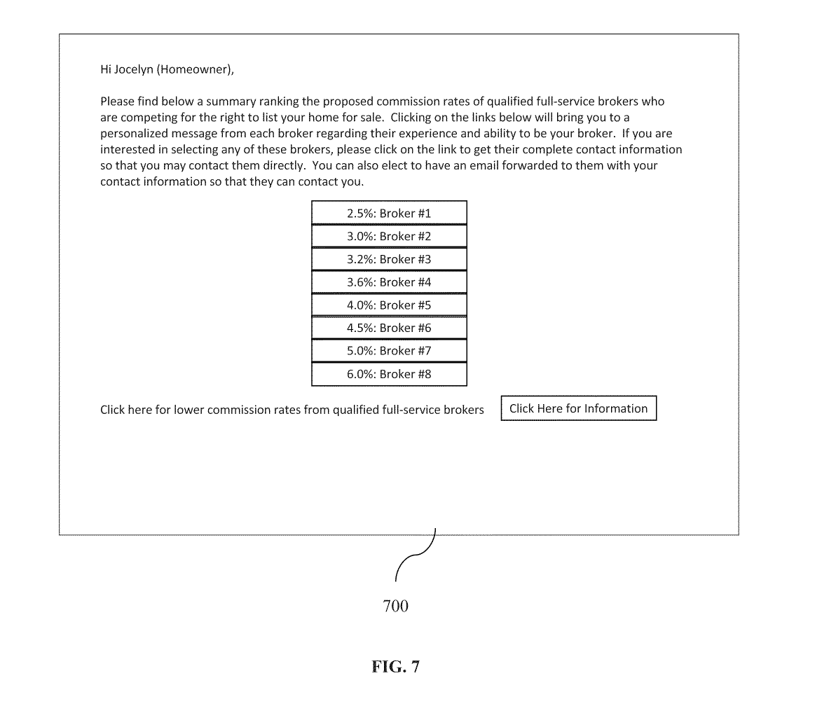

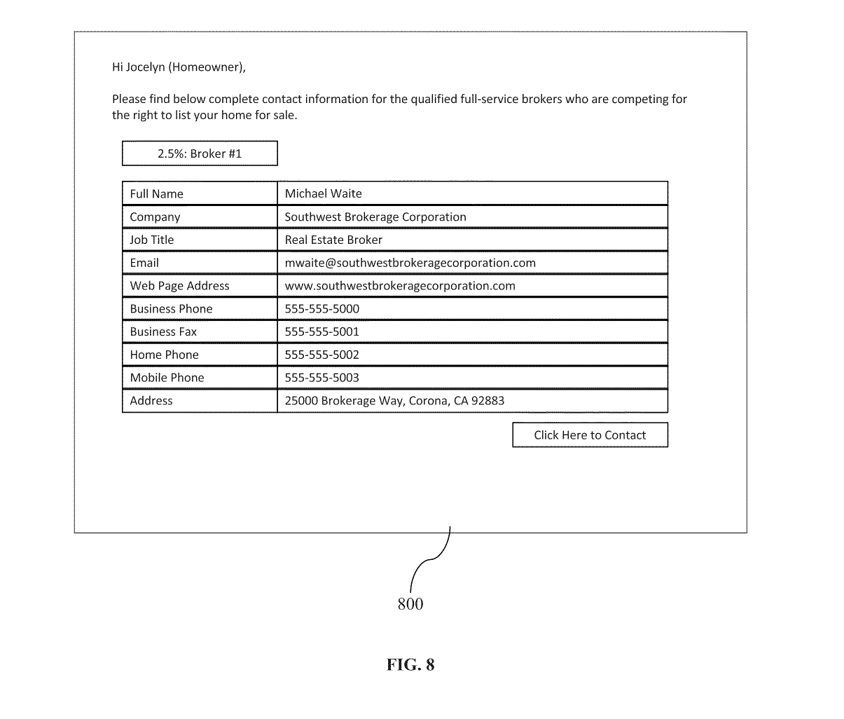

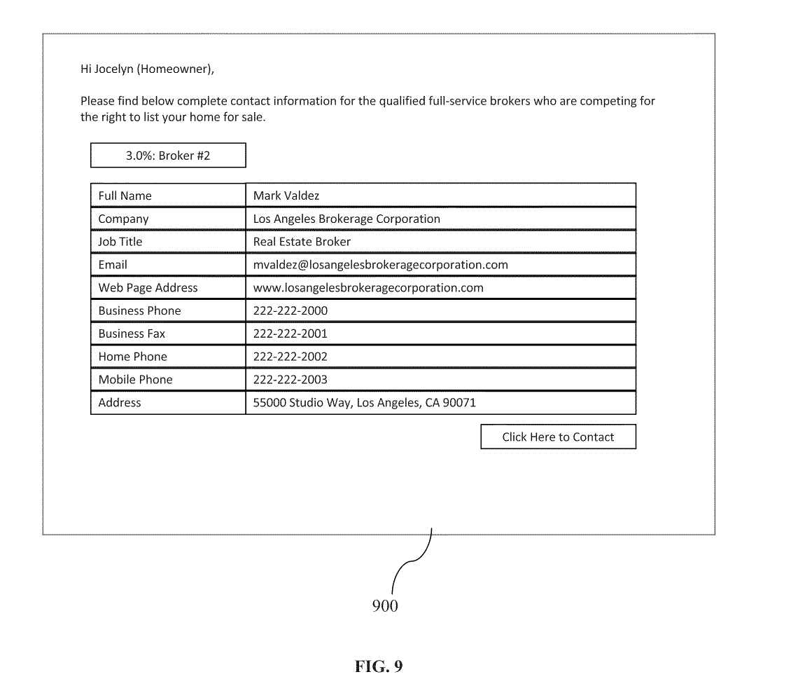

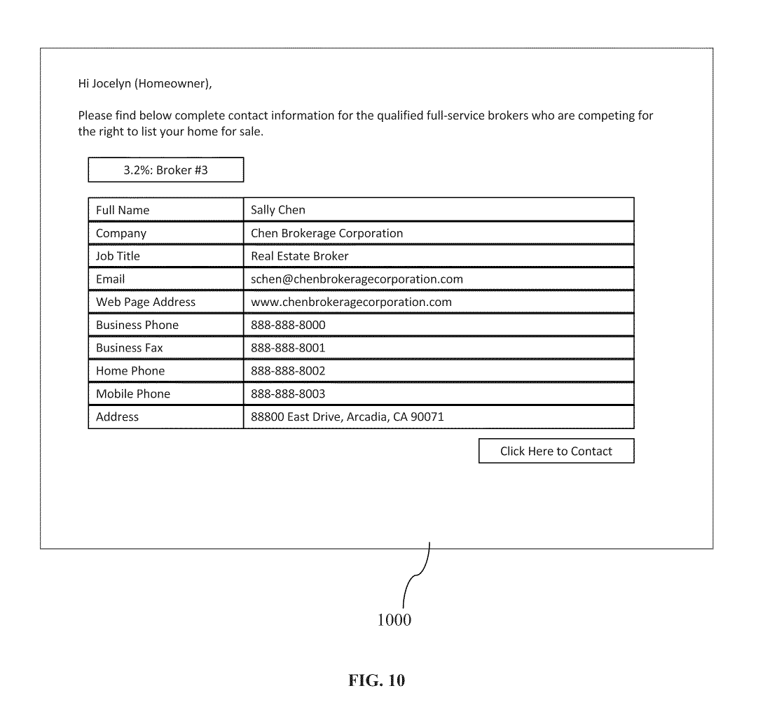

FIG. 7 is a representation of one embodiment of a webpage 700 of potential listing agent's proposed listing terms and a ranking thereof, which webpage 700 is generated by the server 102 in accordance with methods and apparatus of the invention. FIG. 8 is a representation of one embodiment of a webpage 800 providing information from one potential listing agent with that agent's proposed listing terms and its ranking, which webpage 800 is generated by the server 102 in accordance with methods and apparatus of the invention. FIG. 9 is a representation of one embodiment of a webpage 900 providing information from another potential listing agent with that agent's proposed listing terms and its ranking, which webpage 900 is generated by the server 102 in accordance with methods and apparatus of the invention. FIG. 10 is a representation of one embodiment of a webpage 1000 providing information from yet another potential listing agent with that agent's proposed listing terms and its ranking, which webpage 1000 is generated by the server 102 in accordance with methods and apparatus of the invention.

In a sixth step 206, the seller reviews the potential listing agent's proposed listing terms (i.e., one or more offers) using the seller's computer 101 or another computer. The seller then makes a decision on the offers (i.e., by rejecting one or more of the offers and/or accepting one of the offers), inputs that decision into the networked communications system 100 using any suitable method and apparatus, and transmits that decision to the server 102. In a further embodiment, the seller's decision on the one or more offers is temporarily or permanently stored in memory of the seller's computer 101 or other computer used by the seller in transmitting that decision to the server 102.

In a seventh step 207, the server 102 then connects the potential listing agent submitting the accepted offer and the seller accepting the offer by transferring the potential listing agent's information (e.g., contact information) and any necessary property information between the seller and potential listing agent Although acceptance of an offer by a seller may or may not result in an executed real estate listing transaction, in this manner, real estate listing transactions are negotiated between sellers and potential listing agents.

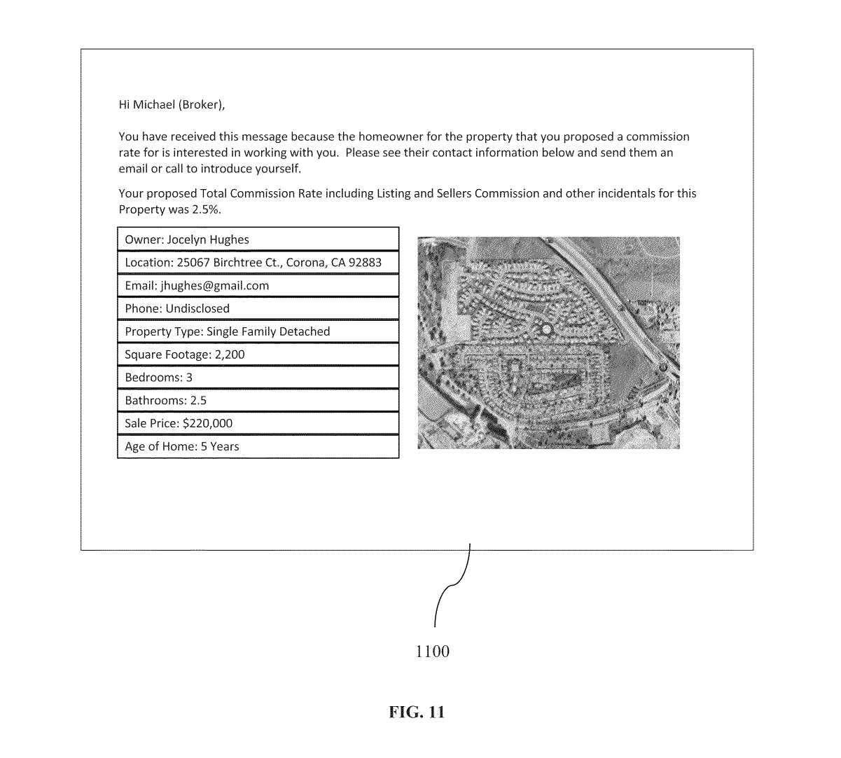

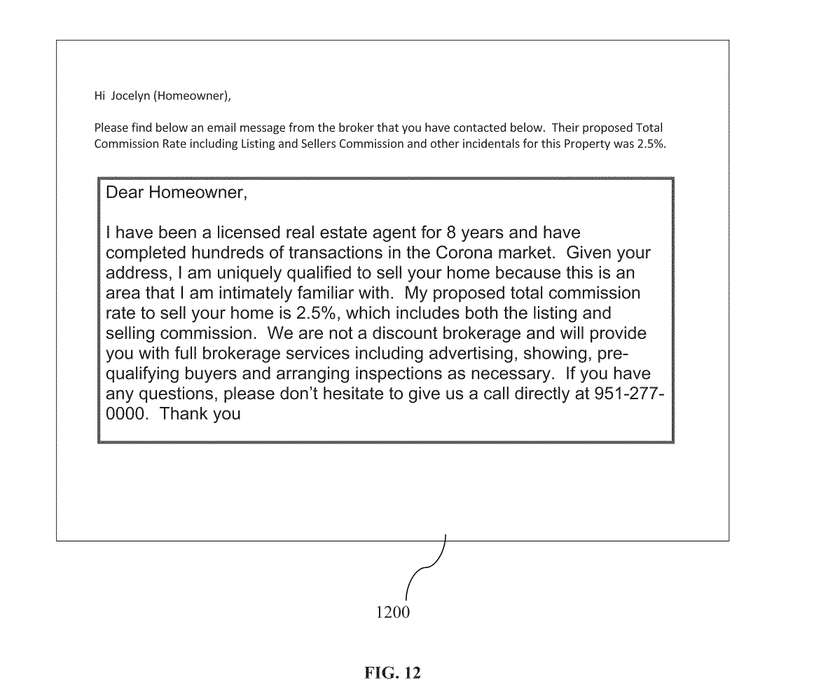

FIG. 11 is a representation of one embodiment of a webpage 1100 providing notification of seller's contact information to the potential listing agent associated with the proposed listing terms selected by the seller, which webpage 1100 is generated by the server 102 in accordance with methods and apparatus of the invention. FIG. 12 is a representation of one embodiment of a communication 1200 from the potential listing agent selected by the seller, which communication 1200 is generated by the server 102 and transmitted to the seller in accordance with methods and apparatus of the invention.

Finally, in an optional eighth step 208, information related to the negotiated real estate listing transaction is stored in the server database 104 for future use, such as statistical analysis.

The present invention provides a method and apparatus where the immense resources of a networked communications system, such as the Internet, allow vast numbers of sellers and agents to communicate with each other and efficiently transact business. The effect of this enhanced coordination is a reduction in commission rates charged by listing agents, as sellers are now able to market their listings to qualified real estate agencies in order to obtain a reduced commission rate as compared to those rates conventionally embodied in real estate listing transactions.

It is to be understood that the terms “agent,” “broker,” and “agency” are used interchangeably herein to refer to the nature of individual or entity to be engaged by a seller a real estate listing transaction. The use of any one of those terms encompasses the remainder of the terms and shall not limit the scope of the claimed invention.

Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language.

What is claimed is:

1. A method for negotiating a real estate listing transaction between a seller and a plurality of real estate listing agencies, the method comprising steps of:
providing a server;
providing at least one computer operable by a seller of real property;
providing at least one computer operable by one or more potential real estate listing agencies for the real property;
networking with each other, using a networked communications system, each of the server, the at least one computer operable by the seller of real property, and the at least one computer operable by the one or more potential real estate listing agencies;
accepting real property information input into the computer operable by the seller and transmitted to the server over the networked communications system;
using the server, generating a webpage displaying at least some of the real property information;
accepting competing offers to list the real property, wherein the competing offers are input into the at least one computer operable by the one or more potential real estate listing agencies and transmitted to the server over the networked communications system;
using the server, processing the competing offers to provide proposed listing terms for the seller; and
transmitting the proposed listing terms to the seller over the networked communications system.

2. The method of claim 1, wherein the networked communications system comprises a global data communications system.

3. The method of claim 1, wherein the networked communications system comprises the Internet.

4. The method of claim 1, wherein the seller's computer interacts with the server by accessing a website hosted on the server.

5. The method of claim 4, wherein the website hosted on the server is accessed indirectly through another networked computer by the seller's computer.

6. The method of claim 1, wherein the at least one computer operable by the one or more potential real estate listing agencies interacts with the server by accessing a website hosted on the server.

7. The method of claim 6, wherein the website hosted on the server is accessed indirectly through another networked computer by the at least one computer operable by the one or more potential real estate listing agencies.

8. The method of claim 1, wherein transmission of information between the seller's computer, the server, and the at least one computer operable by the one or more potential real estate agencies is accomplished using a web browsing application operable on at least one of the seller's computer, the server, and the computer operable by the one or more potential real estate agencies.

9. The method of claim 1, further comprising a step of using the server to generate an introductory webpage providing instructions to the seller on how to negotiate the real estate listing transaction.

10. The method of claim 1, wherein the competing offers comprise a proposed commission rate.

11. The method of claim 1, wherein the step of accepting competing offers to list the real property occurs during a limited time period.

12. The method of claim 1, wherein the step of accepting competing offers to list the real property comprises accepting multiple bids from at least one of the potential real estate listing agencies.

13. The method of claim 1, wherein the step of processing the competing offers comprises organizing the competing offers in a ranking from lowest proposed commission rate to highest proposed commission rate.

14. The method of claim 1, wherein the step of processing the competing offers comprises organizing the competing offers using an auction-type methodology to identify a bid on proposed listing terms having a lowest commission rate.

15. The method of claim 1, wherein the step of transmitting the proposed listing terms to the seller comprises transmitting the potential real estate listing agencies' proposed listing terms and a ranking thereof.

16. The method of claim 1, wherein the step of transmitting the proposed listing terms to the seller comprises transmitting proposed listing terms associated with a winning bid.

17. The method of claim 1, further comprising a step of transmitting a decision on the proposed listing terms made by the seller over the networked communications system.

18. The method of claim 1, further comprising a step of connecting one of the one or more potential real estate listing agencies with the seller.

19. A server comprising an application capable of performing the method of claim 1.

20. A networked communications system comprising the server of claim 19.
